(19) United States
(12) Patent Application Publication
(10) Pub. No.: US 2009/0097144 A1
(43) Pub. Date: Apr. 16, 2009

(54) FAST STEERING MIRROR

(75) Inventors: Shawn L. Oehlke, Crosby, ND (US); Corrie Nygaard, Crosby, ND (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: SEO PRECISION, INC., Crosby, ND (US)

(21) Appl. No.: 11/872,419

(22) Filed: Oct. 15, 2007

(51) Int. Cl. G02B 7/198

(52) U.S. Cl. 359/876; 359/877

(57) ABSTRACT

A fast steering mirror that houses all of the electronics needed to operate the mirror in the mirror, more particular, its base assembly.

### TECHNICAL FIELD

The embodiments of the present invention relate generally to fast steering mirrors, and, more particularly, to compact designs for fast steering mirrors.

### BACKGROUND

Fast Steering Mirrors (FSM) have become key components in diverse applications such as industrial instrumentation, astronomy, laser communications, imaging systems, experimental optical bench strips, and independent research and development projects.

Originally developed for military and aerospace applications, FSMs have been commercialized and incorporated as active mirror elements in high-performance beam stabilization and alignment modules, for example. FSMs can be used to perform a variety of functions including tracking, scanning, pointing, beam stabilization, line of sight stabilization, and alignment. They have become key components in diverse applications such as industrial instrumentation, astronomy, laser communications, imaging systems, experimental optical bench setups, and research and development projects.

FSMs are used in precision-pointing systems to move a light beam quickly, point it toward a specific target, and stabilize it. FSMs rapidly correct for environmental disturbances such as aircraft turbulence or spacecraft structure vibrations.

FSMs typically consist of six main components: voice-coil actuators, flexure suspension system, internal-position feedback sensors, mirror, drive electronics and frame. The voice-coil actuators act as motors and are coupled to the mirror and are used to tilt the mirror. Two voice-coils are coupled on opposite sides of the mirror and operate as a push-pull pair, rotating about the axis that bisects them. Therefore, two actuator pairs are used to produce two orthogonal rotations (θx and θy). The flexure suspension system is used to support the mirror and allows free rotation of the mirror about orthogonal axes while constraining piston, side-to-side, and rotation about the normal axis.

Normally, the electronics that operate and control the steering mirror are located external to the FSM, typically in a rack. It has been found that there are disadvantages associated with such known arrangements as will be described in detail hereinafter. It is thus desirable to produce a FSM that avoids these disadvantages.

### SUMMARY

According to one aspect of the embodiments of the invention, there is provided a fast steering mirror having a base member, a cradle, a mirror, a position sensor circuit board and a controller circuit board. The cradle is pivotally coupled to the base member and the mirror is coupled to the cradle. The position sensor circuit board is located in a cavity of the base for sensing a position of the mirror. The controller circuit board is located in the cavity of the base member for controlling movement of the mirror. A back plate is removably coupled to the base member for sealing the internal cavity from an environment external to the internal cavity, wherein the position sensor and controller circuit boards are independently accessible without disturbing each other when the back plate is removed.

According to another aspect of the invention, there is provided a fast steering mirror including a base assembly, a cradle assembly, a mirror and a plurality pf electronic circuit boards. The base assembly member has four external walls defining an internal cavity. The cradle assembly is pivotally coupled to the base assembly member and the mirror is coupled to the cradle assembly. The plurality of electronic circuit boards for operating the mirror are located in the internal cavity of the base assembly member wherein each of the electronic circuit boards are independently accessible without disturbing the other electronic circuit boards

### BRIEF DESCRIPTION OF THE DRAWINGS

FIG. 1 is a front, perspective view of a fast steering mirror according to an embodiment of the invention in its fully assembled state.

FIG. 2 is a rear, perspective view of the fast steering mirror shown in FIG. 1 in its fully assembled state.

FIG. 3 is a rear, exploded perspective view of the fast steering mirror shown in FIG. 1 with its back cover removed showing internal printed circuit boards.

FIG. 4 is a rear, perspective view of the fast steering mirror shown in FIG. 1 with its back cover removed with the printed circuit boards located inside a base.

FIG. 5 is a rear, perspective view of the fast steering mirror shown in FIG. 4 with its back cover and the printed circuit boards removed.

FIG. 6 is a front, perspective view of the fast steering mirror shown in FIG. 1 with its cover removed to show the mirror.

FIG. 7 is a front, perspective view of the mirror.

FIG. 8 is a rear, perspective view of the mirror.

FIG. 9 is a front, perspective view of the fast steering mirror shown in FIG. 1 with its cover and mirror removed to show an embodiment of the cradle assembly.

FIG. 10 is a front, perspective view of the cradle assembly shown in FIG. 9.

FIG. 11 is a rear, perspective view of the cradle assembly shown in FIG. 9.

FIG. 12 is a front, perspective view of the fast steering mirror shown in FIG. 1 with its cover, mirror and cradle assembly removed.

FIG. 13 is a perspective view of a portion of an actuator of a motor assembly.

FIG. 14 is a front, perspective view of the fast steering mirror shown in FIG. 1 with its cover, mirror, cradle assembly and one actuator (of a motor assembly) removed.

FIG. 15 is a front, perspective view of the fats steering mirror shown in FIG. 1 with its cover, mirror, cradle assembly, one actuator (of a motor assembly) and one magnet removed.

FIG. 16 is a front, perspective view of the fast steering mirror shown in FIG. 1 with its cover, mirror, cradle assembly, one actuator, one magnet and one coil of a motor assembly removed.

FIG. 17 is a front perspective view of the fast steering mirror shown in FIG. 1 with its cover, mirror, cradle assembly, all motors, magnets and coils removed as well as a top cover and ring support arrangement removed.

FIG. 18 is the fast steering mirror as shown in FIG. 17 with the top half of a flexure yoke removed to show a pair of flexure pivots.

FIG. 19 is the fast steering mirror shown in FIG. 18 with the pair of flexure pivots additionally removed.

FIG. 20 is the fast steering mirror shown in FIG. 19 with one of the flexure clamps additionally removed.

FIG. 21 is a front, perspective view of a fast steering mirror with its cover removed to show the mirror according to another embodiment of the invention.

FIG. 22 is a front, perspective view of the fast steering mirror shown in FIG. 21 with its cover and mirror removed to show the cradle assembly.

FIG. 23 is a rear, perspective view of the cradle assembly shown in FIG. 21.

FIG. 24 is a front, perspective view of the fast steering mirror shown in FIG. 21 with its cover, mirror and cradle assembly removed.

FIGS. 25 and 26 are rear perspective views of the mirror assembly with the base removed to show the rear side of the cradle assembly, the motors and the position sensors.

FIG. 27 is a rear perspective view of the base assembly with its base plate removed of the fast steering mirror shown in FIG. 21.

FIG. 28 is a perspective view of an armature of a motor used in the fast steering mirror shown in FIG. 21.

FIG. 29 is a perspective view of an armature of a motor used in the fast steering mirror shown in FIG. 21.

### DETAILED DESCRIPTION

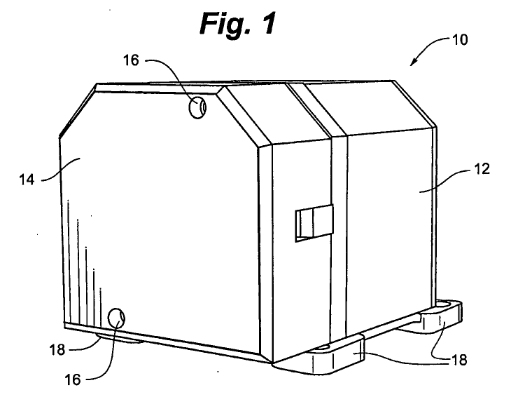

FIG. 1 is a front, perspective view of a fast steering mirror 10 according to an embodiment of the invention in its fully assembled state. The fast steering mirror 10 has a base assembly 12 and a cover 14. In a preferred embodiment, the cover 14 snap fits over the base assembly 12 and is secured thereto with a couple of screws 16. The base assembly 12 has four mounting brackets 18 located on its underside which can be used to mount the fast steering mirror 10 to a structure (not shown) using bolts (not shown), for example, extending through a hole formed in each mounting bracket 18. Alternatively, the base assembly 12 may be mounted on any platform using any other conventional coupling method, such as screwing, welding, soldering or laser welding, for example. The base assembly 12 is preferably made of a stiff and lightweight material such as 40% SIC/6061-T6 Aluminum matrix which is commercially available from Advanced Composite Materials Corporation of Greer, S.C. and the cover 14 is preferably made of aluminum or a non-outgassing plastic. Of course other materials known or later developed may be used. The cover 14 is removed during operation of the fast steering mirror.

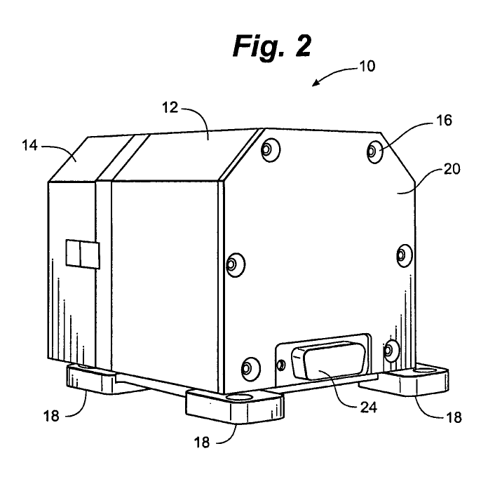

FIG. 2 is a rear, perspective view of the fast steering mirror 10 shown in FIG. 1 in its fully assembled state. A back plate 20 is secured to a back side of the base assembly 12 and is preferably secured thereto using screws 16, for example. An electrical connector 24 extends through the back plate 20 and allows an electrical connection between electronics housed within the base assembly 12, as will be described hereinafter, and electronics external to the fast steering mirror 10. As will be described in greater detail hereinafter, there are multiple printed circuit boards located inside the base assembly 12. Electronics external to the steering mirror 10 may communicate with the electronics located in the base assembly 12 via electrical connector 24. The fast steering mirror 10 is a compact structure measuring preferably about 2 inches by about 2 inches. Of course, it may be larger or smaller depending on the size of the mirror needed.

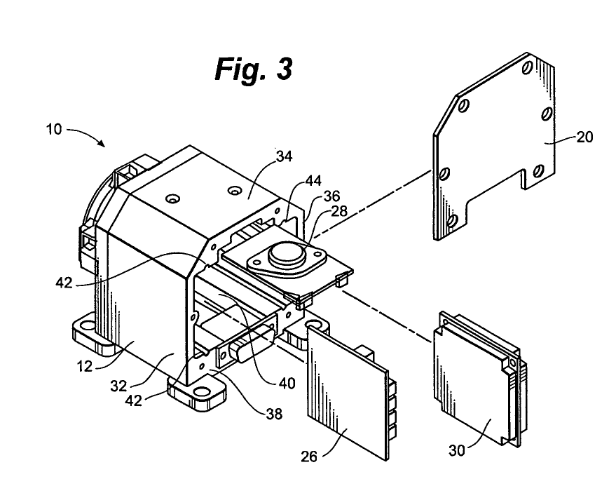

FIG. 3 is a rear, exploded perspective view of the fast steering mirror 10 shown in FIG. 1 with its back plate 20 removed showing multiple internal printed circuit boards 26, 28, 30. The base assembly 12 has four external walls 32, 34, 36, 38 that define an internal cavity 40. Internal cavity 40 houses preferably three printed circuit boards or cards 26, 28, 30. In particular, the boards include a motor driver board 28, a position sensor board 26 and a controller board 30. The motor driver board 28 has circuitry that delivers power to the other circuit boards as well as other components of the fast steering mirror 10 as will be described. The position sensor board 26 has circuitry that detects the position of a cradle assembly 46 coupled to a mirror 48 as will be described in detail hereinafter. The controller board 30 has circuitry that controls movement of the cradle assembly 46 and mirror 48 as will be described in detail hereinafter. The internal cavity has a first pair of slots 42 formed on an interior surface of two of its external walls as well as a second pair of slots 44. The slots hold the position sensor board 26 and the controller bard 30 in position inside the internal cavity of the base assembly 12. Like the other boards, the motor driver board 28 is held in a slotted recess (not shown) at the top of the internal cavity of the base assembly 12. Thus, all of the electronics needed to operate the steering mirror 10 are located within the housing of the steering mirror, more particularly, its base assembly.

As previously described, normally, the electronics that operate a fast steering mirror 10 are located external to the mirror housing itself, typically in a rack, as is well known. There are many disadvantages associated with placing the electronics in an external rack. First, this increases the overall size of the system since precious rack space is being taken up by these boards. Second, the electronics used with fast steering mirror 10 systems are typically analog, not digital. Typically, the other boards in the rack have digital circuitry on them. When analog cards are placed in a rack next to digital cards, the analog circuitry on the analog boards picks up noise from the digital electronics which produces a noisy mirror.

An advantage of placing the electronic boards within the base assembly 12 itself is that a faraday cage may be simply implemented by lining the internal cavity of the base assembly 12 with a gold or copper mesh film, commercially available from W.L. Gore and Associates, for example. In addition, for outerspace applications, the fast steering mirror 10 may be made impervious to space radiation by radiation hardening the base assembly 12 and cover 14 as is well known to one of ordinary skill in the art.

Another advantage offered by having the electronics located within the base assembly 12 is that the temperature inside the base assembly 12 is stabilized. Typically, for rack mounted boards, a relatively large heat sink is provided on the board itself. Because these board mounted heat sinks get hot and radiate heat, fans have to be positioned in the rack to cool down the boards. This requires more space in the rack and thus increases the overall size of the system. Also, this made such systems unsuitable for vacuum environments like outerspace where fans can't be used. In addition, the board secured heat sink itself has issues with vibrational settings such as on a spacecraft, in which case they tend to shear off the board. This has the potential to cause fluctuations in position measurements because, as the analog sensor circuitry warms up, this causes the measurement position of the mirror to change.

By housing the various electronic boards inside the base assembly 12, the fast steering mirror 10 does not need an external rack as is currently used to hold these components. Instead, the steering mirror is compact in design and space requirements. If a circuit board needs to be serviced or replaced, it is very easy to gain access to the board simply by removing the back plate 20 from the base assembly 12. Because of each boards' vertical alignment, access to any of the boards may be had without disturbing the other boards. Thus, each of the boards may be accessed individually. Surface mount technology was used to shrink the size of the board to about 2 inches by about 2 inches instead of the size typically found in a rack which did not allow them to be placed inside the fast steering mirror 10.

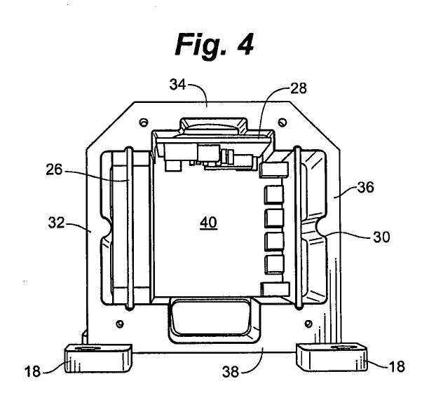

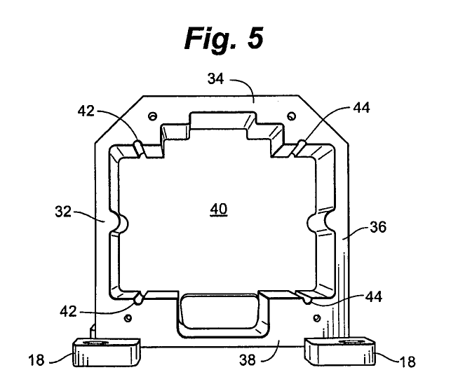

FIG. 4 is a rear, perspective view of the fast steering mirror 10 shown in FIG. 1 with its back plate 20 removed with the printed circuit boards 26, 28, 30 located inside the internal cavity 40 of the base assembly 12. FIG. 5 is a rear, perspective view of the fast steering mirror shown in FIG. 4 with its back plate 20 and the printed circuit boards removed. The first and second pair of slots 42 and 44 are easily seen in this view.

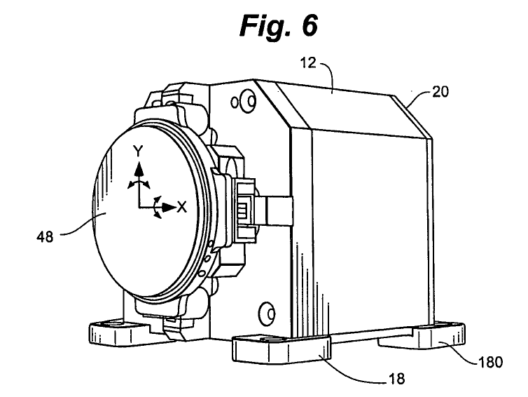

FIG. 6 is a front, perspective view of the fast steering mirror 10 shown in FIG. 1 with its cover 14 removed to show the mirror 48. With the cover 14 removed, the mirror 48 is exposed. The cover 14 is removed when the mirror is operational. The mirror 48 is circular in shape and preferably has a diameter of about two inches although other sizes and shapes may be used. Located underneath the mirror 48 are several components that allow the mirror to move as is required for a fast steering mirror 10. As will be described in detail hereinafter, the mirror 48 is arranged on the base assembly 12 so as to rotate around an X axis and a Y axis which are perpendicular to each other as shown but is substantially fixed against rotation around Z axis, which is perpendicular to the plane formed by the X and Y axes and substantially fixed against translation along all three axes.

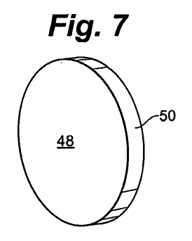

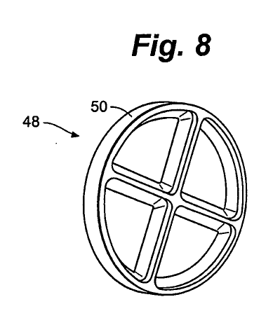

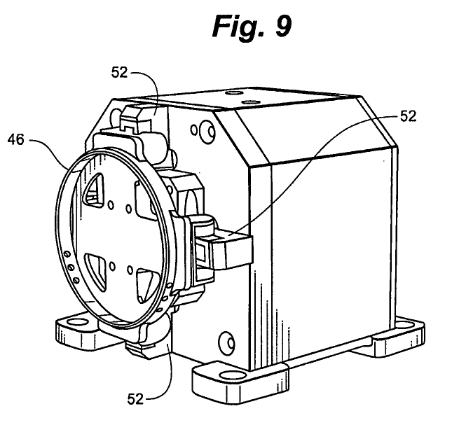

FIG. 7 is a front, perspective view of the mirror 48. The mirror 48 has side walls 50 that allow it to be coupled to a cradle assembly 46 (see FIG. 9) without actually physically touching the cradle assembly 46 itself as will be described in detail hereinafter. The mirror 48 is shown with a circular reflective surface; however, the reflective surface and the mirror may have other shapes. FIG. 8 is a rear, perspective view of the mirror 48. The mirror may be formed from I-220-B, Type II, hot pressed beryllium block, which is available from Brush Wellman Corporation of Cleveland, Ohio.

FIG. 9 is a front, perspective view of the fast steering mirror 10 with its cover 14 and mirror 48 removed to show an embodiment of the cradle assembly 46. The cradle assembly 46 is coupled to the mirror 48 as will be described hereinafter. The cradle assembly 46 itself is pivotally coupled to the base assembly 12 so that it can rotate about the X and Y axes as discussed. The mirror 48 is fixedly mounted to the cradle assembly 46 and thus moves with the cradle assembly 46. Located under the cradle assembly 46 are motor assemblies 52, position sensors (not shown) and flexures (not shown).

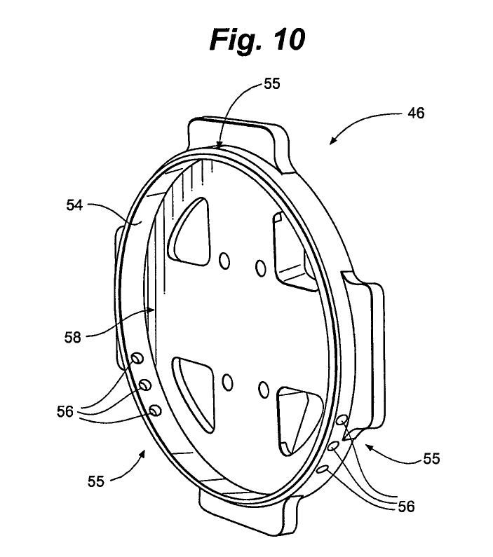

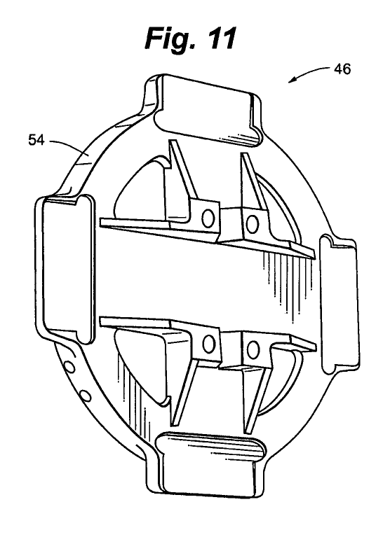

FIG. 10 is a front, perspective view of the cradle assembly 46 shown in FIG. 9. FIG. 11 is a rear, perspective view of the cradle assembly 46 shown in FIG. 9. As can be seen in FIGS. 9-11, the cradle assembly 46 has a side wall 54 around its perimeter defining a cavity 58 on its front surface. There are three groups 55 of three holes 56 drilled through the cradle assembly sidewall 54. As was previously mentioned, the mirror 48 has a side wall 50 and is sized to fit inside the cavity 58 of the cradle assembly 46 and be adjacent to but not physically abut the cradle assembly's side wall 54. An epoxy such as a non-outgassing epoxy used for bonding glass to metal is introduced through the holes 56 drilled in the cradle assembly's sidewall 54 and the epoxy contacts the mirror's side wall 50. Once the epoxy sets, the mirror 48 is coupled to the cradle assembly 46 by an epoxy joint. Thus, the cradle assembly 46 does not itself physically touch the mirror 48. The epoxy joints between the sides of the mirror and the sidewall of the cradle assembly 46 cures in a vertical direction (not transversely) so it does not pinch the mirror. This provides the benefit of not structurally altering the reflective surface of the mirror 48.

The cradle assembly 46 itself needs to be stiff yet light weight. Preferably the cradle assembly 46 is made of a material with a low temperature co-efficient such as titanium or aluminum or any later developed similar material. As will be described hereinafter, all of the hardware is coupled to the cradle assembly 46. The cradle assembly 46 design allows for the entire mechanical interface between the mirror 48 and base assembly 12 substantially to be coupled before the addition of the mirror 48 itself. This allows for the prestressing of the entire system insuring that mechanical stresses do not affect the optical quality once the mirror 48 has been installed in the system. The mirror 48 can be easily installed and replaced, or exchanged, if needed. In a preferred embodiment the cradle assembly 46 is prestressed or stress relieved before the mirror is mounted thereto in accordance with MIL-H-6088 by placing it in an air circulating oven at room temperature and then heating to 350° F. for 4±0.25 hours followed by a slow oven cool (turn off heating element but do not open oven doors) to 100° F. before removing the cradle from the oven to cool at room temperature.

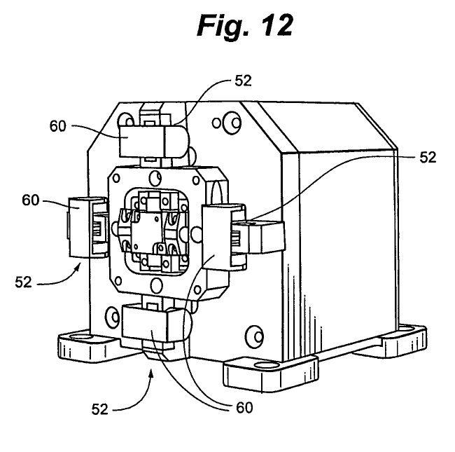

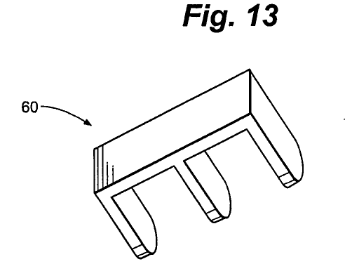

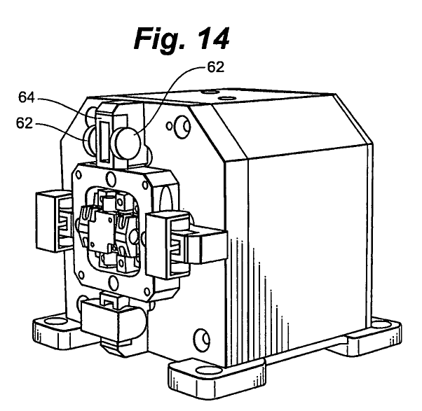

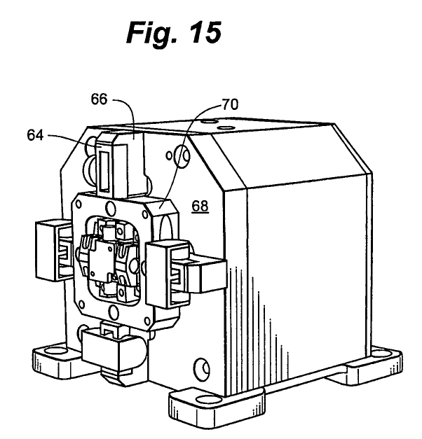

FIG. 12 is a front, perspective view of the fast steering mirror 10 shown in FIG. 1 with its cover 14, mirror 48 and cradle assembly 46 removed. Located under the cradle assembly 46 are four motor assemblies 52 each of which consists of an armature 60 (See FIGS. 12 and 13) a pair of magnets 62 (See FIG. 14) and a coil 64 (See FIGS. 14 and 15). FIG. 13 is a perspective view of a portion of an actuator of a motor assembly. The actuator has three arms the outer two of which each has a magnet coupled thereto (see FIG. 14). The center arm fits in a center opening of the coil as seen in FIG. 14. The magnets 62 and armatures 60 are coupled to the cradle assembly 46 and thus the magnets 62 and armature 60 move with the cradle assembly 46 while the coils 64 are coupled to the base assembly 12. Because the coils 64 generate heat, by coupling them to the base assembly 12, the base assembly 12 acts as a heat sink.

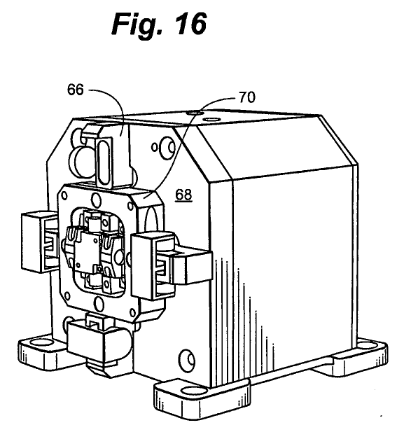

FIG. 16 is a front, perspective view of the fast steering mirror shown in FIG. 1 with its cover, mirror, cradle assembly, one actuator, one magnet and one coil of a motor assembly removed. With reference to FIGS. 15 and 16, the coils 64 reside on a coil bracket 66 that is secured to a top cover 68 of the base assembly 12 that shields the coils 64 from the electronics located within the base assembly 12. The top cover 68 isolates the internal cavity 40 of the base assembly 12 from the motor assemblies 52, cradle assemblies 46 and mirror 48. The top cover 68 can be held in place using screws, for example. Located on the top cover are coil brackets and a support ring 70. The coil brackets and support ring may be independent components from the top cover or they may be formed as a integral unit with the top cover. The support ring and end of the coil bracket opposite from the support ring provide EMI shielding of the coil. The base assembly 12 itself provides EMI shielding. Each coil 64 sits on a coil bracket and is encapsulated at two, opposite ends. This provides to advantages; the coil is heat sunk to the base and any noise generated off coil is captured by the outside tag and grounded back into the base assembly 12. The motor assemblies 52 are well known to those of ordinary skill in the art and need not be described in greater detail.

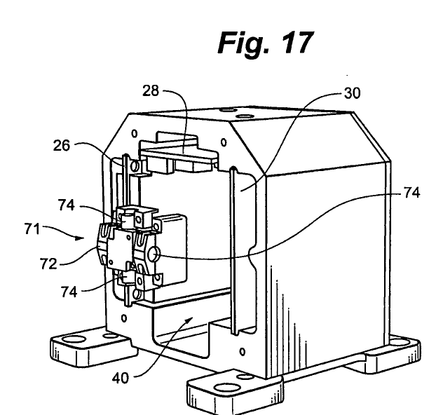

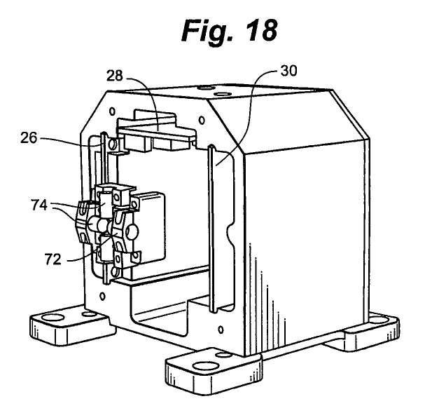

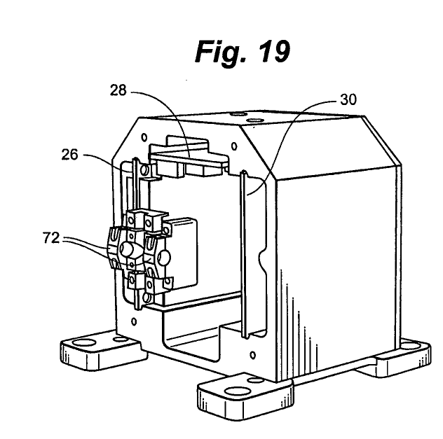

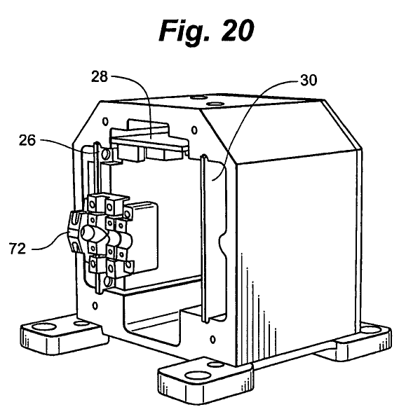

FIG. 17 is a front perspective view of the fast steering mirror 10 shown in FIG. 1 with its cover 14, mirror, cradle assembly, all motor assemblies removed as well as a top cover 14 and support ring 70 removed. The internal cavity 40 of the base assembly 12 can be seen as well as the printed circuit boards 26, 28, 30 housed therein. The center structure 71 includes flexure pivot support elements 72 and flexure pivots 74 that allow the cradle assembly to rotate about the two orthogonal axes. FIG. 18 is the fast steering mirror 10 as shown in FIG. 17 with the top half of a flexure yoke removed to show a pair of flexure pivots 74. FIG. 19 is the fast steering mirror 10 shown in FIG. 18 with a second pair of flexure pivots additionally removed. FIG. 20 is the fast steering mirror 10 shown in FIG. 19 with one of the flexure support elements 72 additionally removed.

In FIGS. 17 and 18 a first and second pair of flexure pivots 74 are shown. The pairs of flexure pivots 74 are arranged in the same way as the motor assemblies because they provide the ability of the cradle assembly to rotate in the force directions provided by the motor assemblies. The flexure pivots are commercially available from the River Hawk Company of New Hartford, N.Y. and C-Flex Bearing Co., Inc, of Frankfort, N.Y., for example. In particular, flexure pivot mounts are provided by an upper and lower flexure yoke and flexure saddles and clamps. Sleeves of the flexure pivots are received in recesses formed in these structures and are held in place by the upper flexure yoke and flexure clamps secured to the lower flexure yoke and flexure saddles respectively. The flexure pivots when secured to each of the pivot mounts and coupled to the back of the cradle assembly by upper flexure yoke permit the cradle assembly and this mirror to rotate about orthogonal axes θx and θy and otherwise restrict movement of the cradle assembly and thus mirror for all other degrees of freedom.

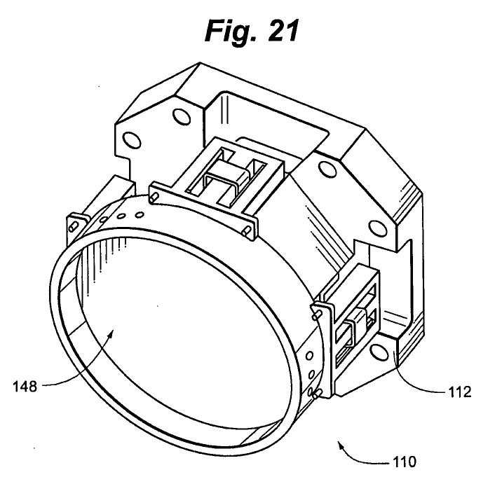

FIG. 21 is a front, perspective view of a fast steering mirror 110 with its cover removed to show the mirror 148 according to another embodiment of the invention. With the cover removed, the mirror 148 is exposed. The mirror 148 is circular in shape and preferably has a diameter of about two inches although other sizes and shapes may be used. Located underneath the mirror 148 are several components that allow the mirror to move as is required for a fast steering mirror 110. As will be described in detail hereinafter, the mirror 148 is arranged on the base assembly 112 so as to rotate around an X axis and a Y axis which are perpendicular to each other as shown but is substantially fixed against rotation around Z axis, which is perpendicular to the plane formed by the X and Y axes and substantially fixed against translation along all three axes.

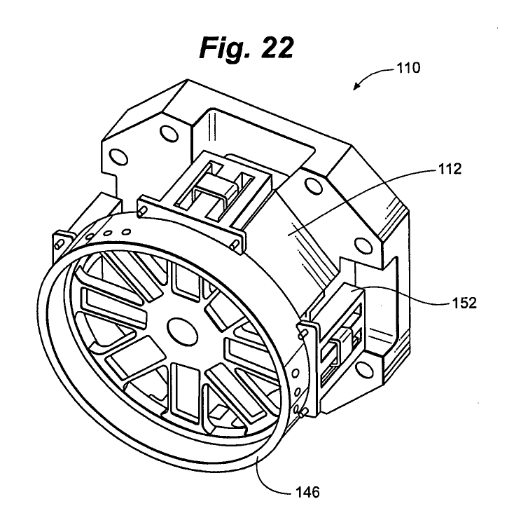

FIG. 22 is a front, perspective view of the fast steering mirror 110 shown in FIG. 21 with its cover and mirror 148 removed to show the cradle assembly 146. The cradle assembly 146 is coupled to the mirror 148 as will be described hereinafter. The cradle assembly 146 itself is pivotally coupled to the base assembly 112 so that it can rotate about the X and Y axes as discussed. The mirror 148 is fixedly mounted to the cradle assembly 146 and thus moves with the cradle assembly 146. Located under the cradle assembly 146 are motor assemblies 152, position sensors (not shown) and flexures (not shown).

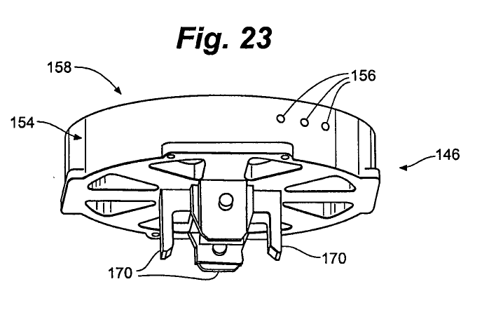

FIG. 23 is a rear, perspective view of the cradle assembly 146 shown in FIG. 21. Like the cradle assembly shown in FIGS. 9-11, the cradle assembly 146 has a side wall 154 around its perimeter defining a cavity 158 on its front surface. There are three groups of three holes 156 drilled through the cradle assembly sidewall 154. As was previously mentioned, the mirror 148 has a side wall 150 and is sized to fit inside the cavity 158 of the cradle assembly 146 and be adjacent to but not physically abut the cradle assembly's side wall 154. An epoxy such as a non-outgassing epoxy used for bonding glass to metal is introduced through the holes 156 drilled in the cradle assembly's sidewall 154 and the epoxy contacts the mirror's side wall 150. Once the epoxy sets, the mirror 148 is coupled to the cradle assembly 146 by an epoxy joint. Thus, the cradle assembly 146 does not itself physically touch the mirror 148. The epoxy joints between the sides of the mirror and the sidewall of the cradle assembly 146 cures in a vertical direction (not transversely) so it does not pinch the mirror. This provides the benefit of not structurally altering the reflective surface of the mirror 148. The underside of the cradle assembly 146 as seen in FIG. 23 has a plurality of projecting tabs 170 that are generally perpendicular to the plane of the cradle assembly 146. As will be described in further detail hereinafter these tabs 170 are used along with position sensors to provide improved mechanical deflection of the mirror while retaining accuracy compared to known systems.

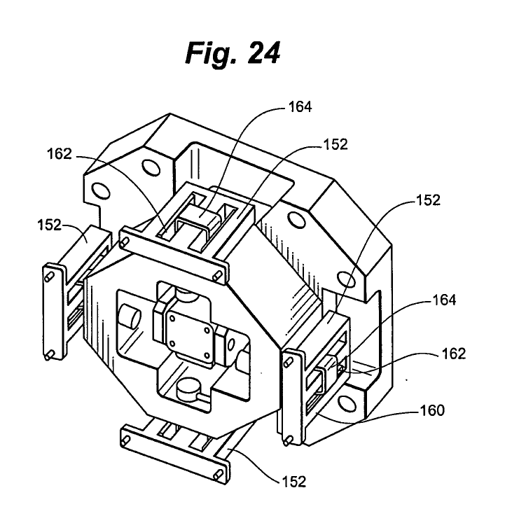

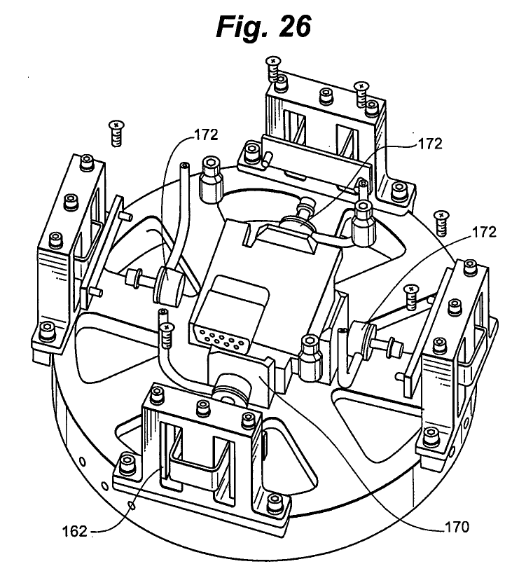

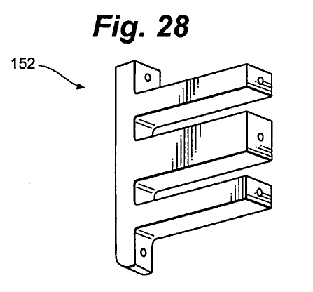

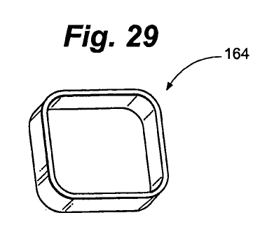

FIG. 24 is a front, perspective view of the fast steering mirror 110 shown in FIG. 21 with its cover, mirror 148 and cradle assembly 146 removed. Located under the cradle assembly 146 are four motor assemblies 152 each of which consists of an armature 160 (See FIG. 28) a pair of magnets 162 and a coil 164 (See FIG. 29). FIG. 28 is a perspective view of the armature of a motor assembly. The armature 160 has three arms the outer two of which each has a magnet coupled to its surface facing the center arm (see 162 in FIG. 26). The coil 164 wraps around the center arm of the armature 160 as seen in FIG. 26. The magnets 162 and armatures 160 are coupled to the cradle assembly 146 and thus the magnets 162 and armature 160 move with the cradle assembly 146 while the coils 164 are coupled to the base assembly 112. Because the coils 164 generate heat, by coupling them to the base assembly 112, the base assembly 112 acts as a heat sink.

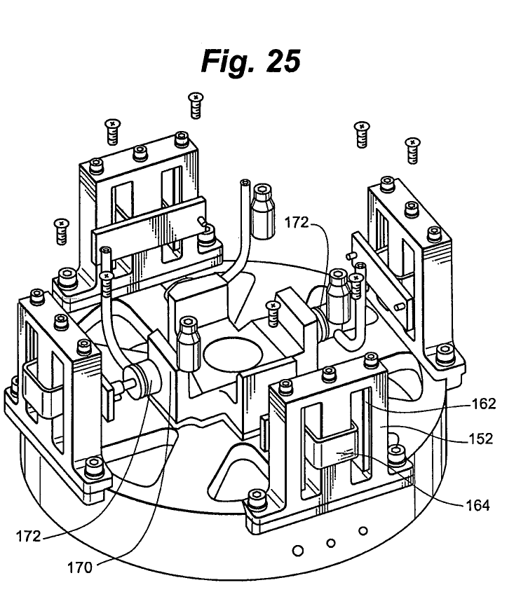

FIGS. 25 and 26 are rear perspective views of the mirror assembly with the base removed to show the rear side of the cradle assembly, the motors and the position sensors 172. It can be seen that there is a position sensor 172 located adjacent to a projecting tab 170 of the cradle assembly. As the mirror moves, and thus the cradle, each sensor is brought either closer to or further away form its respective projecting tab depending on how the mirror moves. By positioning the sensors in such a way, the mechanical deflection of the mirror is increased to about +/−7° compared to known systems that look at the back side of the mirror which limit deflections to about +/−1.5° while still maintaining a position sensor resolution of better than 500 nano-radians. In many instances, this larger deflection would obviate the need for a gimbal assembly traditionally used with smaller travel fast steering mirrors.

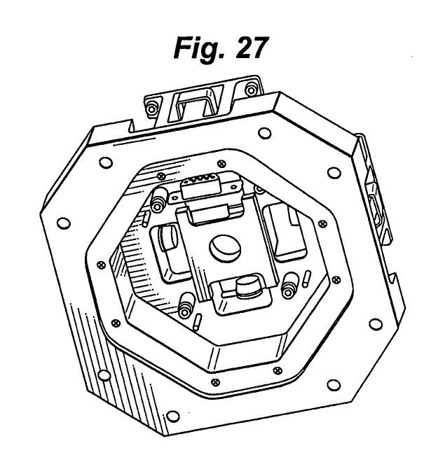

FIG. 27 is a rear perspective view of the base assembly with its base plate removed of the fast steering mirror shown in FIG. 21. Not shown in this embodiment are the slots to retain the printed circuit boards, however, the same or similar configuration as that shown in FIGS. 3, 4 and 5 would be used.

What is claimed is:

1. A fast steering mirror comprising:
a base member;
a cradle pivotally coupled to the base member;
a mirror coupled to the cradle;
a position sensor circuit board located in a cavity of the base for sensing a position of the mirror
a controller circuit board located in the cavity of the base member for controlling movement of the mirror;
a back plate removably coupled to the base member for sealing the internal cavity from an environment external to the internal cavity, wherein the position sensor and controller circuit boards are independently accessible without disturbing each other when the back plate is removed.

2. The fast steering mirror of claim 1 wherein the cradle assembly is prestressed before the mirror is mounted thereto.

3. The fast steering mirror of claim 1 wherein an epoxy is used to secure the mirror in the cradle assembly wherein the mirror does not physically contact the cradle assembly.

4. The fast steering mirror of claim 1 wherein the four external walls include a first, a second, a third and a fourth external wall wherein the first and third external wall are generally parallel to one another and the second and fourth external walls extend between the first and third external walls, generally perpendicular thereto;
a first pair of slots formed on an interior surface of the second external wall;
a second pair of slots formed on an interior surface of the fourth external wall wherein the second pair of slots are aligned with the first pair of slots wherein a slot of each the first pair and the second pair holds an edge of one of the plurality of electronic circuit boards within the internal cavity of the base.

5. The fast steering mirror of claim 1 wherein the cradle assembly has a side wall extending around its perimeter which defines a cavity and the mirror has a side wall extending around its perimeter wherein the mirror is sized to fit in the cavity of the cradle assembly with the mirror's side wall adjacent to but not in contact with the cradle assembly's side wall.

6. The fast steering mirror of claim 4 further comprising a back plate removably coupled to the base assembly wherein the base plate is generally perpendicular to the four external walls and covers an opening to the internal cavity of the base plate.

7. The fast steering mirror of claim 6 wherein the boards are arranged so that the plane of the board is generally perpendicular to the base plate.

8. The fast steering mirror of claim 1 wherein the mirror is fixedly coupled to the cradle assembly.

9. The fast steering mirror of claim 1 further comprising a plurality of motors coupled to the cradle assembly wherein a first pair of motor assemblies are coupled on opposite sides of the cradle assembly and operate as a push-pull pair rotating the cradle assembly about an axis that bisects the first pair of motor assemblies in a first rotation and a second pair of motor assemblies coupled on opposite sides of the cradle assembly and operate as a push-pull pair rotating the cradle assembly about an axis that bisects the second pair of motor assemblies in a second rotation orthogonal to the first rotation.

10. A fast steering mirror comprising:
a base assembly member having four external walls defining an internal cavity;
a cradle assembly pivotally coupled to the base assembly member;
a mirror coupled to the cradle assembly;
a plurality of electronic circuit boards for operating the mirror located in the internal cavity of the base assembly member wherein each of the electronic circuit boards are independently accessible without disturbing the other electronic circuit boards.

11. The fast steering mirror of claim 10 wherein the plurality of electronic circuit boards include a power circuit board, a position sensor circuit board and a controller circuit board.

12. The fast steering mirror of claim 10 wherein the cradle assembly is prestressed before the mirror is mounted thereto.

13. The fast steering mirror of claim 10 wherein an epoxy is used to couple the mirror in the cradle assembly wherein the mirror does not physically contact the cradle assembly.

14. The fast steering mirror of claim 10 wherein the four external walls include a first, a second, a third and a fourth external wall wherein the first and third external wall are generally parallel to one another and the second and fourth external walls extend between the first and third external walls, generally perpendicular thereto;
a first pair of slots formed on an interior surface of the second external wall;
a second pair of slots formed on an interior surface of the fourth external wall wherein the second pair of slots are aligned with the first pair of slots wherein a slot of each the first pair and the second pair holds an edge of one of the plurality of electronic circuit boards within the internal cavity of the base.

15. The fast steering mirror of claim 10 wherein the cradle assembly has a side wall extending around its perimeter which defines a cavity and the mirror has a side wall extending around its perimeter wherein the mirror is sized to fit in the cavity of the cradle assembly with the mirror's side wall adjacent to but not in contact with the cradle assembly's side wall.

16. The fast steering mirror of claim 14 further comprising a back plate removably coupled to the base assembly wherein the base plate is generally perpendicular to the four external walls and covers an opening to the internal cavity of the base plate.

17. The fast steering mirror of claim 16 wherein the boards are arranged so that the plane of the board is generally perpendicular to the base plate.

18. The fast steering mirror of claim 10 wherein the mirror is fixedly coupled to the cradle assembly.

19. The fast steering mirror of claim 10 further comprising a plurality of motors coupled to the cradle assembly wherein a first pair of motor assemblies are coupled on opposite sides of the cradle assembly and operate as a push-pull pair rotating the cradle assembly about an axis that bisects the first pair of motor assemblies in a first rotation and a second pair of motor assemblies coupled on opposite sides of the cradle assembly and operate as a push-pull pair rotating the cradle assembly about an axis that bisects the second pair of motor assemblies in a second rotation orthogonal to the first rotation.

20. The fast steering mirror of claim 10 further comprising four position sensors located in the internal cavity wherein the cradle assembly has a rear surface that faces the internal cavity and the rear surface of the cradle assembly has four tabs projecting generally perpendicularly with respect to a major face of the cradle assembly wherein one position sensor is located adjacent to one tab.
